(19) United States
(12) Patent Application Publication
(10) Pub. No.: US 2025/0106599 A1
(43) Pub. Date: Mar. 27, 2025

(54) COMMUNICATION METHOD AND COMMUNICATION APPARATUS

(71) Applicant: HUAWEI TECHNOLOGIES CO., LTD., Shenzhen (CN)

(72) Inventors: Gongzheng ZHANG, Hangzhou (CN); Rong LI, Boulogne Billancourt (FR); Chen XU, Hangzhou (CN); Jian WANG, Hangzhou (CN); Yunfei QIAO, Hangzhou (CN)

(21) Appl. No.: 18/969,862

(22) Filed: Dec. 5, 2024

Related U.S. Application Data
(63) Continuation of application No. PCT/CN2023/098839, filed on Jun. 7, 2023.

(30) Foreign Application Priority Data
Jun. 10, 2022 (CN) 202210651259.7

(51) Int. Cl. H04W 4/14; H04W 28/06

(52) U.S. Cl. CPC H04W 4/14; H04W 28/06

(57) ABSTRACT

A method includes: obtaining first semantic information corresponding to data; converting the first semantic information into second semantic information, where the second semantic information belongs to common semantic information, and the common semantic information is a unified description of same semantics that is provided by different devices; and sending the second semantic information. Based on the method provided in this application, when a semantic extraction model of a transmit device and a semantic understanding model of a receive device are not jointly trained, accuracy of semantic communication between the transmit device and the receive device may be ensured by converting local semantic information into common semantic information.

### CROSS-REFERENCE TO RELATED APPLICATIONS

This application is a continuation of International Application No. PCT/CN2023/098839, filed on Jun. 7, 2023, which claims priority to Chinese Patent Application No. 202210651259.7, filed on Jun. 10, 2022. The disclosures of the aforementioned applications are hereby incorporated by reference in their entireties.

### TECHNICAL FIELD

This disclosure relates to the field of communication technologies, and in particular, to a communication method and a communication apparatus.

### BACKGROUND

As a data volume of a communication system keeps increasing, spectral efficiency of radio resource usage has gradually approached a Shannon capacity. To reduce a requirement for a channel bandwidth in the communication system, a semantic communication mode emerges. Semantic communication means that a transmit end extracts semantic information from raw data, encodes the semantic information, and then sends the semantic information; and a receive end obtains the semantic information through decoding, and then further performs semantic processing based on the semantic information. It can be learned that a communication device in the semantic communication mode performs communication through transmission of the semantic information of the raw data. In comparison with a manner of transmission of the raw data, the bandwidth requirement can be significantly reduced.

Usually, a prerequisite for performing semantic communication between the transmit end and the receive end is that the transmit end and the receive end have a same understanding of the semantic information. That is, semantic representations of the same raw data are the same (or this is understood as that the transmit end and the receive end have a same semantic knowledge base). However, in an actual communication system, diversity of raw data and differences between training models of the transmit end and the receive end all cause different semantic representations of the same raw data. Therefore, joint training needs to be performed on a semantic extraction model of the transmit end and a semantic understanding model of the receive end, so that the semantic extraction model of the transmit end and the semantic understanding model of the receive end have a same semantic knowledge base. However, a joint training manner limits application of the semantic communication in the communication system.

### SUMMARY

Embodiments of this disclosure provide a communication method and a communication apparatus, so that when a transmit device and a receive device do not perform joint training, the transmit device and the receive device can perform semantic communication, to improve accuracy of the semantic communication.

According to a first aspect, this disclosure provides a communication method. Optionally, the method may be performed by a communication device (for example, a terminal device or a network device) configured to send information, may be performed by a component (for example, a processor, a chip, or a chip system) of the communication device, or may be implemented by a logical module or software that can implement all or some of functions of the communication device. The method includes:
obtaining first semantic information corresponding to data; converting the first semantic information into second semantic information, where the second semantic information belongs to common semantic information, and the common semantic information is a unified description of same semantics that is provided by different devices; and sending the second semantic information.

It can be learned that, based on the method described in the first aspect, when a transmit device and a receive device do not perform joint training, the transmit device may convert local semantic information (namely, the first semantic information) into common semantic information (namely, the second semantic information). This ensures that semantic communication can be performed with the receive device, and improves accuracy of the semantic communication in this case.

In some embodiments, the transmit device performs semantic conversion on the first semantic information based on a semantic conversion model, to obtain the second semantic information. Through implementation of the embodiments, the transmit device may convert the local semantic information into the common semantic information by using the semantic conversion model, to improve accuracy of the semantic conversion.

In some embodiments, the first semantic information is obtained by inputting the data into a semantic extraction model. In this case, the transmit device may input training data into the semantic extraction model, to obtain training semantic information; the transmit device inputs the training data into a common semantic extraction model, to obtain label semantic information, where the label semantic information belongs to the common semantic information; and the transmit device performs training based on the training semantic information and the label semantic information, to obtain the semantic conversion model. Through implementation of the embodiments, a local semantic extraction model of the transmit device is aligned with the common semantic extraction model, so that an objective of the semantic conversion model is to implement alignment of the local semantic information (namely, semantic information extracted by the semantic extraction model) and the common semantic information (namely, semantic information extracted by the common semantic extraction model), to improve accuracy of the semantic conversion model.

In some embodiments, the common semantic extraction model is configured by a network device.

In some embodiments, the transmit device performs semantic conversion on the first semantic information based on a representation manner of the common semantic information, to obtain the second semantic information. Through implementation of the embodiments, the transmit device converts the local semantic information based on the representation manner of the common semantic information, so that conversion complexity can be reduced, and conversion efficiency can be improved.

In some embodiments, the representation manner of the common semantic information is configured by a network device or is pre-specified in a protocol.

In some embodiments, the representation manner of the common semantic information includes a semantic vector representation manner, a triplet representation manner, or a directed graph representation manner.

In some embodiments, the second semantic information and the first semantic information correspond to a same semantic level. Through implementation of the embodiment, converted semantic information (namely, the second semantic information) and semantic information that is not converted (namely, the first semantic information) have the same semantic level, so that accuracy of the semantic information obtained through the semantic conversion is improved.

According to a second aspect, this disclosure provides a communication method. Optionally, the method may be performed by a communication device (for example, a terminal device or a network device) configured to receive information, may be performed by a component (for example, a processor, a chip, or a chip system) of the communication device, or may be implemented by a logical module or software that can implement all or some of functions of the communication device. The method includes:

A receive device receives second semantic information, where the second semantic information belongs to common semantic information, and the common semantic information is a unified description of same semantics that is provided by different devices; the receive device converts the second semantic information into third semantic information; and the receive device processes the third semantic information to obtain target information.

It can be learned that, based on the method described in the second aspect, when a transmit device and the receive device do not perform joint training, the receive device may convert common semantic information (namely, the second semantic information) into local semantic information (namely, the third semantic information). This ensures that semantic communication can be performed with the transmit device, and improves accuracy of the semantic communication in this case.

In some embodiments, the receive device performs semantic conversion on the second semantic information based on a semantic conversion model, to obtain the third semantic information. Through implementation of the embodiments, the receive device may convert the common semantic information into the local semantic information by using the semantic conversion model, to improve accuracy of the semantic conversion.

In some embodiments, the target information is obtained by inputting the third semantic information into a semantic understanding model. In this case, the receive device may input training data into a semantic extraction model, to obtain label semantic information, where the semantic extraction model and the semantic understanding model are jointly trained; the receive device inputs the training data into a common semantic extraction model, to obtain training semantic information corresponding to the training data; and the receive device performs training based on the training semantic information and the label semantic information, to obtain the semantic conversion model.

In some embodiments, the common semantic extraction model is configured by a network device.

In some embodiments, the receive device performs semantic conversion on the second semantic information based on a representation manner of the common semantic information, to obtain the third semantic information. Through implementation of the embodiments, the receive device converts the second semantic information based on the representation manner of the common semantic information, so that conversion complexity can be reduced, and conversion efficiency can be improved.

In some embodiments, the representation manner of the common semantic information includes a semantic vector representation manner, a triplet representation manner, or a directed graph representation manner.

In some embodiments, the third semantic information and the second semantic information correspond to a same semantic level. Through implementation of the embodiment, converted semantic information (namely, the third semantic information) and semantic information that is not converted (namely, the second semantic information) have the same semantic level, so that accuracy of the semantic information obtained through the semantic conversion is improved.

According to a third aspect, this disclosure provides a communication method. Optionally, the method may be performed by a communication device (for example, a terminal device or a network device) configured to send information, may be performed by a component (for example, a processor, a chip, or a chip system) of the communication device, or may be implemented by a logical module or software that can implement all or some of functions of the communication device. The method includes:

A transmit device sends a check request message to a receive device, where the check request message is for determining whether descriptions of same semantics that are provided by the receive device and the transmit device are the same; the transmit device receives a check response message from the receive device, where the check response message indicates whether the descriptions of the same semantics are the same; and if the check response message indicates that the descriptions of the same semantics are the same, the transmit device performs semantic communication with the receive device based on a semantic processing model; or if the check response message indicates that the descriptions of the same semantics are different, the transmit device sends first semantic processing model update information to the receive device, and performs semantic communication with the receive device based on a semantic processing model; or the transmit device receives second semantic processing model update information from the receive device, updates a semantic processing model based on the second semantic processing model update information, and performs semantic communication with the receive device based on an updated semantic processing model.

It can be learned that, based on the method described in the third aspect, when the transmit device and the receive device do not perform joint training, if the descriptions of the same semantics that are provided by the transmit device and the receive device are the same, semantic communication can be directly performed; or if the descriptions of the same semantics that are provided by the transmit device and the receive device are different, the transmit device or the receive device updates the semantic processing model of the transmit device or the receive device, and performs communication based on the updated semantic processing model. In this manner, the transmit device and the receive device that do not perform joint training can perform semantic communication, and accuracy of the semantic communication in this case can be improved.

In some embodiments, the semantic processing model includes one or more of a semantic extraction model, a semantic understanding model, or a semantic conversion model.

In some embodiments, the first semantic processing model update information includes a first training dataset, and the first training dataset includes data of the transmit device and corresponding label semantic information.

In some embodiments, the second semantic processing model update information includes a second training dataset, and the second training dataset includes the data of the receive device and corresponding label semantic information. In this case, the transmit device updates the semantic processing model of the transmit device based on the second training dataset.

In some embodiments, before sending the check request message to the receive device, the transmit device sends a semantic communication request message to the receive device; and the transmit device receives a semantic communication acknowledgment message from the receive device. Through implementation of the embodiment, semantic communication is performed only when both the receive device and the transmit device support the semantic communication, so that stability of the semantic communication can be improved.

In some embodiments, the check request message includes test data and semantic information corresponding to the test data.

According to a fourth aspect, this disclosure provides a communication method. Optionally, the method may be performed by a communication device (for example, a terminal device or a network device) configured to receive information, may be performed by a component (for example, a processor, a chip, or a chip system) of the communication device, or may be implemented by a logical module or software that can implement all or some of functions of the communication device. The method includes:

A receive device receives a check request message from a transmit device, where the check request message is for determining whether descriptions of same semantics that are provided by the receive device and the transmit device are the same; the receive device sends a check response message to the transmit device, where the check response message indicates whether the descriptions of the same semantics are the same; and if the check response message indicates that the descriptions of the same semantics are the same, the receive device performs semantic communication with the transmit device based on a semantic processing model; or if the check response message indicates that the descriptions of the same semantics are different, the receive device receives first semantic processing model update information from the transmit device, and updates a semantic processing model based on the first semantic processing model update information; or the receive device sends second semantic processing model update information to the transmit device, and performs semantic communication with the transmit device based on a semantic processing model.

For beneficial effects achieved based on the method described in the fourth aspect, refer to the beneficial effects of implementing the method described in the third aspect. Details are not described herein again.

In some embodiments, the semantic processing model includes one or more of a semantic extraction model, a semantic understanding model, or a semantic conversion model.

In some embodiments, the first semantic processing model update information includes a first training dataset, and the first training dataset includes data of the transmit device and corresponding label semantic information. In this case, the semantic processing model is updated based on the first training dataset.

In some embodiments, the second semantic processing model update information includes a second training dataset, and the second training dataset includes data of the receive device and corresponding label semantic information.

In some embodiments, before receiving the check request message from the transmit device, the receive device may further receive a semantic communication request message from the transmit device; and the receive device sends a semantic communication acknowledgment message to the transmit device based on the semantic communication request message.

In some embodiments, the check request message includes test data and semantic information corresponding to the test data.

According to a fifth aspect, this disclosure provides a communication apparatus. The communication apparatus may be a communication device (for example, a terminal device or a network device) on a transmit side (configured to send information), may be an apparatus in the communication device, or may be an apparatus that can be used together with the communication device. The communication apparatus may alternatively be a chip system. The communication apparatus may perform the method according to any one of the first aspect or the third aspect. A function of the communication apparatus may be implemented by hardware, or may be implemented by executing corresponding software by hardware. The hardware or the software includes one or more units or modules corresponding to the foregoing functions. The unit or the module may be software and/or hardware. For operations performed by the communication apparatus and beneficial effects, refer to the method and beneficial effects in any one of the first aspect or the third aspect.

According to a sixth aspect, this disclosure provides a communication apparatus. The communication apparatus may be a communication device (for example, a terminal device or a network device) on a receive side (configured to receive information), may be an apparatus in the communication device, or may be an apparatus that can be used together with the communication device. The communication apparatus may alternatively be a chip system. The communication apparatus may perform the method according to any one of the second aspect or the fourth aspect. A function of the communication apparatus may be implemented by hardware, or may be implemented by executing corresponding software by hardware. The hardware or the software includes one or more units or modules corresponding to the foregoing functions. The unit or the module may be software and/or hardware. For operations performed by the communication apparatus and beneficial effects, refer to the method and beneficial effects in any one of the second aspect or the fourth aspect.

According to a seventh aspect, this disclosure provides a communication apparatus. The communication apparatus includes a processor, and when the processor invokes a computer program in a memory, the method according to any one of the first aspect or the third aspect is performed.

According to an eighth aspect, this disclosure provides a communication apparatus. The communication apparatus includes a processor, and when the processor invokes a computer program in a memory, the method according to any one of the second aspect or the fourth aspect is performed.

According to a ninth aspect, this disclosure provides a communication apparatus. The communication apparatus includes a processor and a memory, and the processor and the memory are coupled. The processor is configured to implement the method according to any one of the first aspect or the third aspect.

According to a tenth aspect, this disclosure provides a communication apparatus. The communication apparatus includes a processor and a memory, and the processor and the memory are coupled. The processor is configured to implement the method according to any one of the second aspect or the fourth aspect.

According to an eleventh aspect, this disclosure provides a communication apparatus. The communication apparatus includes a processor, a memory, and a transceiver, and the processor and the memory are coupled. The transceiver is configured to send and receive data, and the processor is configured to implement the method according to any one of the first aspect or the third aspect.

According to a twelfth aspect, this disclosure provides a communication apparatus. The communication apparatus includes a processor, a memory, and a transceiver, and the processor and the memory are coupled. The transceiver is configured to send and receive data, and the processor is configured to implement the method according to any one of the second aspect or the fourth aspect.

According to a thirteenth aspect, this disclosure provides a communication apparatus. The communication apparatus includes a processor and an interface, the interface is configured to receive or output a signal, and the processor is configured to implement the method according to any one of the first aspect or the third aspect by using a logic circuit or executing code instructions.

According to a fourteenth aspect, this disclosure provides a communication apparatus. The communication apparatus includes a processor and an interface, the interface is configured to receive or output a signal, and the processor is configured to implement the method according to any one of the second aspect or the fourth aspect by using a logic circuit or executing code instructions.

According to a fifteenth aspect, this disclosure provides a communication system. The communication system includes a communication apparatus on a transmit side and a communication apparatus on a receive side. The communication apparatus on the transmit side includes the communication apparatus according to the fifth aspect, the seventh aspect, the ninth aspect, the eleventh aspect, or the thirteenth aspect. The communication apparatus on the receive side includes the communication apparatus according to the sixth aspect, the eighth aspect, the tenth aspect, the twelfth aspect, or the fourteenth aspect.

According to a sixteenth aspect, this disclosure provides a computer-readable storage medium, where the storage medium stores a computer program or instructions, and when the computer program or the instructions are executed by a communication apparatus, the method according to any one of the first aspect or the third aspect is implemented, or the method according to any one of the second aspect or the fourth aspect is implemented.

According to a seventeenth aspect, this disclosure provides a computer program product including instructions. When a computer reads and executes the computer program product, a computer is enabled to perform the method according to any one of the first aspect or the third aspect, or a computer is enabled to perform the method according to any one of the second aspect or the fourth aspect.

### BRIEF DESCRIPTION OF DRAWINGS

FIG. 1 is a diagram of a system architecture according to this disclosure;

FIG. 2 is a diagram of a semantic communication system according to this disclosure;

FIG. 3 is a schematic flowchart of a communication method according to this disclosure;

FIG. 4a is a diagram of semantic information according to this disclosure;

FIG. 4b is a schematic flowchart of obtaining a semantic conversion model according to this disclosure;

FIG. 4c is a diagram of another semantic communication system according to this disclosure;

FIG. 5 is a schematic flowchart of another communication method according to this disclosure;

FIG. 6 is a diagram of a structure of a communication apparatus according to this disclosure;

FIG. 7 is a diagram of a structure of another communication apparatus according to this disclosure; and

FIG. 8 is a diagram of a structure of a chip according to this disclosure.

### DESCRIPTION OF EMBODIMENTS

The following further describes specific embodiments of this disclosure in detail with reference to the accompanying drawings.

The terms “first”, “second”, and the like in the specification, the claims, and the accompanying drawings of this disclosure are used to distinguish between different objects, but are not used to describe a specific sequence. In addition, the terms “including” and “having” and any other variants thereof are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

An “embodiment” mentioned in the specification indicates that a particular feature, structure, or characteristic described with reference to this embodiment may be included in at least one embodiment of this disclosure. The phrase shown in various locations in the specification may not necessarily refer to a same embodiment, and is not an independent or optional embodiment exclusive from another embodiment. It is explicitly and implicitly understood by a person skilled in the art that embodiments described in the specification may be combined with another embodiment.

In this disclosure, “at least one (item)” means one or more, “a plurality of” means two or more, and “at least two (items)” means two or three or more. “And/or” is used to describe an association relationship between associated objects, and indicates that three relationships may exist. For example, “A and/or B” may indicate: only A exists, only B exists, and both A and B exist. A and B may be singular or plural. The character “/” generally indicates an “or” relationship between the associated objects. “At least one of the following items (pieces)” or a similar expression thereof means any combination of these items, including a single item (piece) or any combination of a plurality of items (pieces). For example, at least one item (piece) of a, b, or c may indicate a, b, c, a and b, a and c, b and c, or a, b, and c, where a, b, and c may be singular or plural.

To better understand embodiments of this disclosure, the following first describes a system architecture in embodiments of this disclosure.

The technical solutions in embodiments of this disclosure may be applied to various communication systems, for example, a global system for mobile communications (GSM), a code division multiple access (CDMA) system, a wideband code division multiple access (WCDMA) system, a general packet radio service (GPRS) system, a long term evolution (LTE) system, an LTE frequency division duplex (FDD) system, LTE time division duplex (TDD) system, a universal mobile telecommunications system (UMTS), a worldwide interoperability for microwave access (WiMAX) communication system, a 5th generation (G) system, a 6th generation (6G) system, a device-to-device (D2D) system, a vehicle-to-everything (V2X) system, new radio (NR) system, and a future communication system.

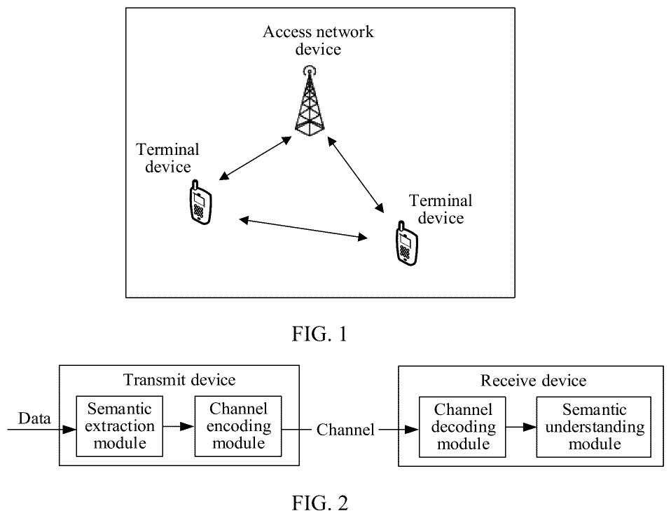

FIG. 1 is a diagram of a system architecture according to an embodiment of this disclosure. As shown in FIG. 1, the system architecture includes a network device and a terminal device. The following separately describes the terminal device and the network device in the system architecture in FIG. 1.

### 1. Terminal Device

The terminal device includes a device that provides voice and/or data connectivity for a user. For example, the terminal device is a device that has a wireless transceiver function, and may be deployed on land, including an indoor device or an outdoor device, a handheld device, a wearable device, or a vehicle-mounted device; or may be deployed on a water surface (for example, on a ship); or may be deployed in the air (for example, on an airplane, a balloon, or a satellite). The terminal device may be a mobile phone, a tablet computer (e.g. a Pad), a computer having a wireless transceiver function, a virtual reality (VR) terminal, an augmented reality (AR) terminal, a wireless terminal in industrial control, a vehicle-mounted terminal, a wireless terminal in self-driving, a wireless terminal in telemedicine, a wireless terminal in a smart grid, a wireless terminal in transportation safety, a wireless terminal in a smart city, a wireless terminal in a smart home, a wearable terminal, or the like. An application scenario is not limited in embodiments of this disclosure. The terminal device may also be sometimes referred to as a terminal, user equipment (UE), an access terminal, a vehicle-mounted terminal, a terminal in industrial control, a mobile station, a remote station, a remote terminal, a mobile device, a wireless communication device, or the like. The terminal may alternatively be fixed or movable. It may be understood that all or some of functions of the terminal in this disclosure may alternatively be implemented by using a software function running on hardware, or may be implemented by using an instantiated virtualization function on a platform (for example, a cloud platform).

### 2. Network Device

The network device (which may also be referred to as an access network device) is a node or a device that connects a terminal device to a wireless network, and an interface between the access network device and the terminal device may be a Uu interface (also referred to as an air interface). Certainly, in future communication, names of these interfaces may remain unchanged, or may be replaced by other names.

The access network device may be any device having a wireless transceiver function, and includes but not limited to: a next generation NodeB (gNB) in a 5G communication system, an evolved NodeB (eNB), a next generation evolved NodeB (ng-eNB), a wireless backhaul device, a radio network controller (RNC), a NodeB (NB), a home base station ((home evolved NodeB (HeNB) or (home NodeB (HNB)), a baseband unit (BBU), a transmission reception point (TRP), a transmission point (TP), a mobile switching center, a device that undertakes a base station function in device-to-device (D2D), vehicle-to-everything (V2X), and machine-to-machine (M2M) communication, or the like. The access network device may further include a network device in a non-terrestrial network (NTN) communication system, in other words, may be deployed on a high-altitude platform, a satellite, or the like. In addition, the access network device may be a central unit (CU) and/or a distributed unit (DU). The CU and the DU each have some functions of the base station. For example, the CU is responsible for processing a non-real-time protocol and service, and implements functions of a radio resource control (RRC) layer and a packet data convergence protocol (PDCP) layer. The DU is responsible for processing a physical layer protocol and a real-time service, and implements functions of a radio link control (RLC) layer, a media access control (MAC) layer, and a physical layer (PHY).

It should be noted that, only two terminal devices and one access network device are used as an example for description in FIG. 1, and this cannot be considered as a specific limitation on the technical solutions of this disclosure. For example, the system architecture of this disclosure may further include one or more terminal devices and/or a plurality of access network devices. Semantic communication in this disclosure may occur between terminal devices in FIG. 1, or may occur between the network device and the terminal device in FIG. 1. In other words, a transmit device in this disclosure may be a terminal device or a network device, and a receive device may be a terminal device or a network device.

For ease of understanding of content of the solutions, the following further explains and describes some terms in embodiments of this disclosure, to facilitate understanding by a person skilled in the art.

### (1) Neural Network

The neural network may include neurons. The neuron may be an operation unit that uses xₛ as an input. An output of the operation unit may be shown as Formula (1):

$${h}_{W , b} ( x ) = f ( {\sum }_{s = 1}^{n} {W}_{s} {x}_{s} + b ) \qquad ( 1 )$$

s=1, 2, . . . , or n, n is a natural number greater than 1, Wₛ is a weight of xₛ, and b is a bias of the neuron. f is an activation function of the neuron, and is for introducing a non-linear feature into the neural network, to convert an input signal in the neuron into an output signal. The output signal of the activation function may be used as an input of a next convolutional layer. The activation function may be a sigmoid function. The neural network is a network formed by connecting a plurality of single neurons together. To be specific, an output of a neuron may be an input of another neuron. An input of each neuron may be connected to a local receptive field of a previous layer to extract a feature of the local receptive field. The local receptive field may be a region including several neurons.

### (2) Deep Neural Network (DNN)

The DNN is also referred to as a multi-layer neural network, and may be understood as a neural network having a plurality of hidden layers. The DNN is divided based on locations of different layers, so that the neural network in the DNN may be divided into three types of layers: an input layer, a hidden layer, and an output layer. Generally, a 1^{st} layer is the input layer, a last layer is the output layer, and a middle layer is the hidden layer. Layers are fully connected. To be specific, any neuron at an ih layer is necessarily connected to any neuron at an (i+1)th layer.

Although it seems that the DNN is complex, it is not complex in terms of work at each layer. Simply speaking, the DNN satisfies the following linear relationship expression: y=α(Wx+b), where X is an input vector, Y is an output vector, b is a bias vector, W is a weight matrix (also referred to as a coefficient), and α( ) is an activation function. At each layer, the output vector Y is obtained by performing such a simple operation on the input vector X. Due to a large quantity of DNN layers, quantities of coefficients W and bias vectors b are also large. The parameters are defined in the DNN as follows: Using the coefficient W as an example, it is assumed that in a three-layer DNN, and a linear coefficient from a 4^{th} neuron at a 2^{nd} layer to a 2^{nd} neuron at a 3^{rd} layer is defined as W₂₄³, where the superscript 3 represents a layer at which the coefficient W is located, and the subscripts correspond to an output 3^{rd}-layer index 2 and an input 2^{nd}-layer index 4.

In conclusion, a coefficient from a kth neuron at an (L−1)^{th} layer to a j^{th} neuron at an L^{th} layer is defined as Wⱼₖ^{L}.

It should be noted that the input layer does not have the parameter W. In the deep neural network, more hidden layers make the network more capable of describing a complex case in the real world. Theoretically, a model with more parameters has higher complexity and a larger “capacity”. It indicates that the model can complete a more complex learning task. Training the deep neural network is a process of learning a weight matrix, and a final objective of the training is to obtain a weight matrix (a weight matrix formed by vectors W at a plurality of layers) of all layers of a trained deep neural network.

### (3) Convolutional Neural Network (CNN)

The CNN is a deep neural network with a convolutional structure. The convolutional neural network includes a feature extractor including a convolutional layer and a sub-sampling layer. The feature extractor may be considered as a filter. A convolution process may be considered as performing convolution by using a trainable filter and an input image or a convolution feature map. The convolutional layer is a neuron layer that is in the convolutional neural network and at which convolution processing is performed on an input signal. At the convolutional layer of the convolutional neural network, one neuron may be connected only to some adjacent-layer neurons. One convolutional layer usually includes several feature maps, and each feature map may include some neurons that are in a rectangular arrangement. Neurons in a same feature map share a weight, and the weight shared herein is a convolution kernel. Weight sharing may be understood as that an image information extraction manner is irrelevant to a location. A principle implied herein is that statistical information of a part of an image is the same as that of another part. This means that image information learned in a part can also be used in another part. Therefore, the same image information obtained through learning can be used for all locations on the image. At a same convolutional layer, a plurality of convolution kernels may be for extracting different image information. Usually, a larger quantity of convolution kernels indicates richer image information reflected in a convolution operation.

The convolution kernel may be initialized in a form of a random-size matrix. In a process of training the convolutional neural network, an appropriate weight may be obtained through learning for the convolution kernel. In addition, a benefit directly brought by the weight sharing is that connections among layers of the convolutional neural network are reduced, and an overfitting risk is reduced at the same time.

### (4) Recurrent Neural Network (RNN)

In the real world, a plurality of elements are ordered and interconnected. To enable a machine to have a memory capability like a human, inference is performed based on context content. Therefore, the RNN emerges.

The RNN is for processing sequence data. To be specific, a current output of a sequence is also related to a previous output. That is, an output of the RNN needs to depend on current input information and historical memory information. A specific representation form is that the network memorizes previous information and applies the previous information to calculation of the current output. To be specific, nodes at the hidden layer are no longer disconnected but are connected, and an input of the hidden layer not only includes an output of the input layer, but also includes an output of the hidden layer at a previous moment. Theoretically, the RNN can process sequence data of any length. Training for the RNN is the same as training for a conventional CNN or DNN. An error back propagation algorithm is also used, but there is a difference: If network unfolding is performed on the RNN, a parameter (for example, W) in the RNN is shared. This is different from the conventional neural network in the foregoing example. In addition, during use of a gradient descent algorithm, an output in each step depends on both a network in a current step and a network status in several previous steps. The learning algorithm is referred to as a back propagation through time (BPTT) algorithm.

### (5) Generative Adversarial Network

The generative adversarial network (GAN) is a deep learning model. The model includes at least two modules: One module is a generative model, and the other module is a discriminative model. The two modules are for learning through gaming with each other, to generate a better output. Both the generative model and the discriminative model may be neural networks, and may specifically be deep neural networks or convolutional neural networks. A basic principle of the GAN is as follows: Using a GAN for generating a picture as an example, it is assumed that there are two networks: G (Generator) and D (Discriminator). G is a network for generating a picture. G receives random noise z, and generates the picture by using the noise, where the picture is denoted as G(z). D is a discriminator network for determining whether a picture is “real”. An input parameter of D is x, x represents a picture, and an output D(x) represents a probability that x is a real picture. If a value of D(x) is 1, it indicates that the picture is 100% real. If a value of D(x) is 0, it indicates that the picture cannot be real. In a process of training the generative adversarial network, an objective of the generative network G is to generate a picture that is as real as possible to deceive the discriminative network D, and an objective of the discriminative network D is to distinguish between the picture generated by G and a real picture as much as possible. In this way, a dynamic “gaming” process, namely, “adversary” in the “generative adversarial network”, exists between G and D. A final gaming result is that in an ideal state, G may generate a picture G(z) that is to be difficultly distinguished from a real picture, and it is difficult for D to determine whether the picture generated by G is real, to be specific, D(G(z))=0.5. In this way, an excellent generative model G is obtained, and can be for generating a picture.

### (6) Semantic Communication

FIG. 2 is a semantic communication system according to this disclosure. The semantic communication system includes a transmit device, a receive device, and a channel for communication between the transmit device and the receive device. The transmit device includes a semantic extraction module and a channel encoding module. The receive device includes a channel decoding module and a semantic understanding module. It should be learned that an algorithm in the semantic extraction module (or the semantic understanding module) includes but is not limited to one or more of the neural network, the DNN, the CNN, the RNN, or the GAN mentioned above.

In the semantic communication system shown in FIG. 2, the transmit device extracts semantic information from data by using the semantic extraction module (also referred to as a semantic extraction model) of the transmit device, and then sends semantic information to the receive device after performing channel encoding on the semantic information by using the channel encoding module. After performing channel decoding on a signal from the transmit device by using the channel decoding module, the receive device obtains the semantic information, and processes the semantic information by using the semantic understanding module (also referred to as a semantic understanding model) of the receive device, to obtain target information.

In other words, semantic communication means that the transmit device extracts main information (which may be understood as to-be-transmitted information or semantic information) from raw data (also referred to as to-be-sent raw data), removes redundant information from the raw data, and sends the main information to the receive device. Further, after receiving the main information, the receive device understands the main information, to obtain information that the transmit device expects to convey. It can be learned that, according to such a communication method, a data transmission amount can be reduced, and communication resources can be saved.

It can be learned that a basis of the semantic communication is that the transmit device and the receive device have a same cognition of the semantic information. Generally, the semantic extraction model and the semantic understanding model are jointly trained, so that two parties of the semantic communication have the same cognition of the semantic information. However, such a method greatly limits actual application of the semantic communication.

This disclosure provides a communication method and a communication apparatus, so that the semantic extraction model of the transmit device and the semantic understanding model of the receive device still have the same cognition of the semantic information when joint training is not performed. The following further describes the communication method and the communication apparatus provided in embodiments of this disclosure.

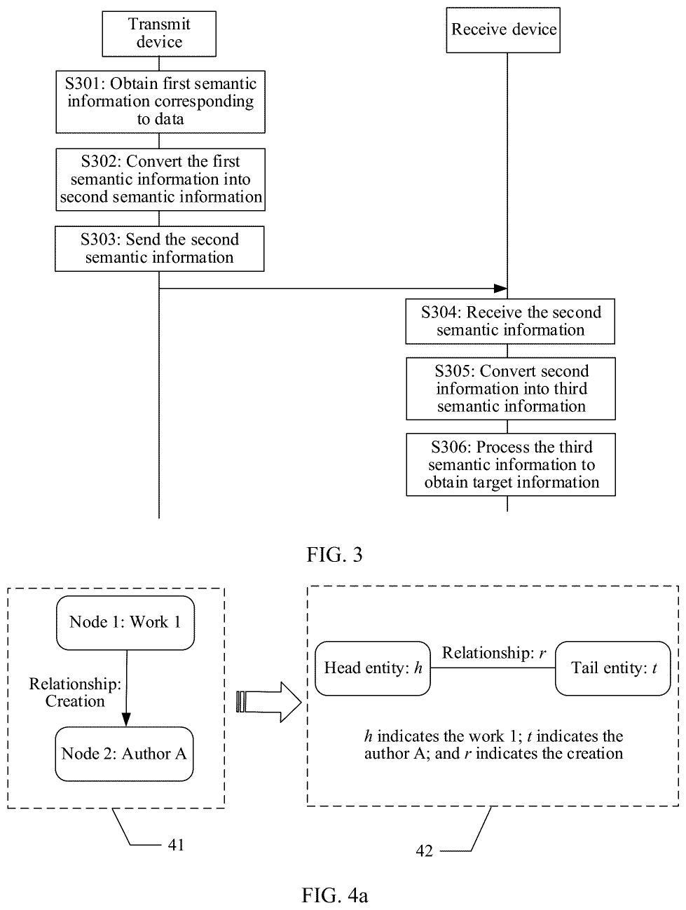

FIG. 3 is a schematic flowchart of a communication method according to an embodiment of this disclosure. In the method described in FIG. 3, a semantic extraction model of a transmit device and a semantic understanding model of a receive device do not need to be jointly trained, and can still have a same cognition of semantic information. In FIG. 3, an example in which a communication device (e.g. the transmit device or the receive device) is used as an execution body of the method is used. The execution body of the method is not limited in this disclosure. For example, the communication device in FIG. 3 may alternatively be an apparatus, a chip, a chip system, or a processor that supports the communication device in implementing the method, or may be a logical module or software that can implement all or some of functions of the communication device.

S301: The transmit device obtains first semantic information corresponding to data.

The transmit device extracts the first semantic information from the data (e.g. to-be-sent raw data) based on the semantic extraction model. A type of the data may be one or more of an image, a text, a video, or a voice. The semantic extraction model may be a model based on one or more algorithms of a neural network, a DNN, a CNN, an RNN, or a GAN.

It may be understood that the semantic extraction model is a semantic extraction model obtained by the transmit device through training based on data corresponding to the transmit device (namely, data stored in, generated by, or obtained by the transmit device through another channel). Therefore, semantic information extracted based on the semantic extraction model can fit the data of the transmit device, and the semantic information (for example, the first semantic information) extracted by using the semantic extraction model may be understood as local semantic information belonging to the transmit device.

S302: The transmit device converts the first semantic information into second semantic information, where the second semantic information belongs to common semantic information. The common semantic information is a unified description of same semantics that is provided by different devices.

It should be understood that the common semantic information is the unified description of the same semantics that is provided by different devices. In other words, different devices represent semantic information of the same semantics in a same manner, and content represented by the semantic information is also the same.

In other words, when the transmit device and the receive device do not perform joint training, to ensure that the transmit device and the receive device have a same cognition of the semantic information, the transmit device may convert the first semantic information (namely, semantic information that may not be understood by the receive device) belonging to the local semantic information into the second semantic information (namely, semantic information that can be understood by the receive device) belonging to the common semantic information. A representation manner of the first semantic information is different from a representation manner of the second semantic information, but content represented by the first semantic information is the same as content represented by the second semantic information. In some embodiments, the second semantic information and the first semantic information correspond to a same semantic level.

The representation manner of the semantic information includes but is not limited to a semantic vector representation manner, a triplet representation manner, or a directed graph representation manner. The content represented by the semantic information includes nodes and relationships between the nodes. The nodes include categories, entities, attributes, or the like. The relationships are for limiting relationships between the categories, relationships between the entities, relationships between the attributes, or relationships between the categories/entities and the attributes. The semantic level is a level of a data extraction degree or a semantic concept. For example, an animal or a plant is a semantic level, a cat (belonging to a category of the animal) may be considered as another semantic level, and a Persian cat (belonging to a category of the cat) may be considered as another semantic level.

For example, for a text “on a sunny day, a white-haired old man sits on a bench in a park and feeds a Persian cat”, the transmit device obtains, from the text by using the semantic extraction model, the content represented by the first semantic information, that is, “an old man feeds a cat”. In addition, the representation manner of the first semantic information is the directed graph representation manner. If a representation manner of the common semantic information is the triplet manner, the content represented by the second semantic information into which the first semantic information is converted by a transmit end is “the old man feeds the cat”, and the representation manner of the second semantic information is the triplet manner. It can be learned that the content represented by the first semantic information is the same as the content represented by the second semantic information, the semantic level of the first semantic information is the same as the semantic level of the second semantic information, and the representation manner of the first semantic information is different from the representation manner of the second semantic information.

The following further describes a manner of converting the local semantic information into the common semantic information, including the following manners.

Manner 1: Conversion is performed based on the representation manner of the common semantic information.

In other words, after obtaining the first semantic information, the transmit device may perform semantic conversion on the first semantic information based on the representation manner of the common semantic information, to obtain the second semantic information. The representation manner of the common semantic information includes but is not limited to the semantic vector representation manner, the triplet representation manner, or the directed graph representation manner.

In some embodiments, semantic conversion is performed on the first semantic information based on a mapping relationship between the representation manner of the common semantic information and the representation manner of the first semantic information, to obtain the second semantic information. The mapping relationship between the representation manner of the common semantic information and the representation manner of the first semantic information may also be understood as a mapping relationship between semantic elements in different representation manners of semantic information.

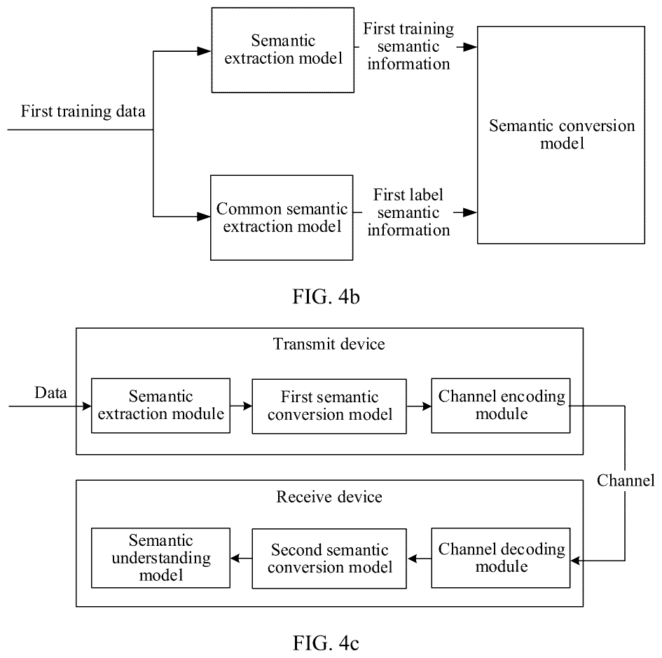

For example, the representation manner of the common semantic information is the triplet manner, and the representation manner of the first semantic information is the directed graph representation manner. In this case, the semantic extraction model of the transmit device obtains first semantic information of a to-be-sent picture, where semantic content of the first semantic information is “a work 1 is created by an author A”, and a representation manner is the directed graph representation manner, as shown by a module 41 in FIG. 4a. Semantic conversion is performed on the first semantic information based on a mapping relationship between each node in a directed graph and an entity in a triplet, to obtain second semantic information in the triplet representation manner, as shown by a module 42 in FIG. 4a. In the triplet (h, r, t), h and t belong to category entities in the triplet (where h is a head entity, and t is a tail entity), and r represents a relationship between the category entities. In other words, h indicates the work 1, t indicates the author A, and r indicates that a relationship between the work 1 and the author A is a creation relationship.

In some embodiments, the representation manner of the common semantic information may be configured by a network device or pre-specified in a protocol.

Manner 2: Conversion is performed based on a semantic conversion model.

In other words, after obtaining the first semantic information, the transmit device performs semantic conversion on the first semantic information based on the semantic conversion model of the transmit end, to obtain the second semantic information. The semantic conversion model may be configured by a network device or predefined in a protocol. It is not difficult to understand that semantic conversion is performed by using the semantic conversion model, so that a matching degree between the first semantic information and the second semantic information can be improved, and accuracy of the second semantic information obtained through conversion can be improved.

In some embodiments, after inputting the data into the semantic extraction model, the transmit device obtains the first semantic information of the data. In this case, to enable the transmit device and the receive device to have the same cognition of the semantic information, both a semantic processing model of the transmit device and a semantic processing model of the receive device may be aligned with a common semantic processing model. The semantic processing model includes one or more of the semantic conversion model, the semantic extraction model, or the semantic understanding model. The common semantic processing model may be configured by the network device.

An example in which the semantic extraction model of the transmit device is aligned with a common semantic extraction model is used for description. FIG. 4b is a schematic flowchart of obtaining a semantic conversion model. In FIG. 4b, the transmit device inputs training data (referred to as first training data for short below) into the semantic extraction model, to obtain training semantic information (referred to as first training semantic information for short below). In addition, the first training data is input into the common semantic extraction model, to obtain label semantic information (referred to as first label semantic information for short below) corresponding to the first training data. The first label semantic information belongs to the common semantic information. Further, training is performed based on the first training semantic information and the first label semantic information, to obtain the semantic conversion model. In this way, an objective of the semantic conversion model is to learn a mapping relationship between the first training semantic information and the first label semantic information, so that after the first training semantic information is input into the semantic conversion model, first training semantic information obtained through conversion can be as close as possible to the first label semantic information. The common semantic extraction model may be configured by the network device.

In some embodiments, if the semantic extraction model of the transmit device is the common semantic extraction model, the first semantic information obtained by the transmit device by using the semantic extraction model (namely, the common semantic extraction model) is the common semantic information. In this case, the transmit end does not need to convert the first semantic information in S302.

S303: The transmit device sends the second semantic information.

After the transmit device obtains the second semantic information, the transmit device encodes the second semantic information to obtain a codeword corresponding to the second semantic information, and sends the codeword corresponding to the second semantic information to the receive device. It should be learned that the encoding includes but is not limited to source encoding, channel encoding, joint source encoding and channel encoding (which may be understood as that the source encoding and the channel encoding are jointly performed), and the like.

For example, the second semantic information is “category 1, category 2, and relationship” represented in the triplet manner. In this case, the transmit device may encode “category 1”, “category 2”, and “relationship” into a bit stream through source encoding, and then, the bit stream is encoded by using a channel encoding technology and transmitted to the receive device. Alternatively, the transmit device may perform joint source encoding and channel encoding on “category 1”, “category 2”, and “relationship”, and map “category 1”, “category 2”, and “relationship” to transmission bits or symbols.

It can be learned that, according to the communication method shown in S301 to S303, the transmit device may convert the local semantic information of the transmit device into the common semantic information that can be understood by a receive end, to ensure that the transmit device and the receive device have the same cognition of the semantic information. In this way, semantic communication can be performed between the transmit device and the receive device, so that accuracy of the semantic communication is improved.

S304: The receive device receives the second semantic information, where the second semantic information belongs to the common semantic information.

The receive device receives the codeword that corresponds to the second semantic information and that is sent by the transmit end, and decodes the codeword corresponding to the second semantic information, to obtain the second semantic information. The decoding includes but is not limited to source decoding, channel decoding, joint source decoding and channel decoding, and the like.

S305: The receive device converts second semantic information into third semantic information.

When the transmit device and the receive device do not perform joint training, to ensure that the transmit device and the receive device have the same cognition of the semantic information, the transmit device sends the common semantic information to the receive device, but an input of the semantic understanding model used by the receive device to process (or understand) the semantic information is a local semantic information type corresponding to the receive device. In this case, the receive device may convert the second semantic information belonging to the common semantic information into the third semantic information belonging to the local semantic information of the receive device. The representation manner of the second semantic information is different from a representation manner of the third semantic information, but the content represented by the second semantic information is the same as content represented by the third semantic information. In some embodiments, the third semantic information and the second semantic information correspond to a same semantic level.

The following further describes a manner of converting the common semantic information into the local semantic information of the receive device, including the following manners.

Manner 1: Conversion is performed based on the representation manner of the common semantic information.

In other words, after obtaining the second semantic information, the receive device may perform semantic conversion on the second semantic information based on the representation manner of the common semantic information, to obtain the third semantic information.

In some embodiments, semantic conversion is performed, based on a mapping relationship between the representation manner of the common semantic information and a representation manner of the local semantic information of the receive device (namely, the representation manner of the third semantic information), on the second semantic information belonging to the common semantic information, to obtain the third semantic information. The mapping relationship between the representation manner of the common semantic information and the representation manner of the local semantic information of the receive device may also be understood as a mapping relationship between semantic elements in the representation manner of the common semantic information and the representation manner of the local semantic information of the receive device.

For example, the representation manner of the common semantic information is the triplet manner, and the representation manner of the local semantic information of the receive device is the semantic vector manner. In this case, the receive device obtains second semantic information. Semantic content of the second semantic information is “a work 1 is created by an author A”, and the second semantic information is a triplet (h, r, t), where h indicates the work 1, t indicates the author A, and r indicates that a relationship between the work 1 and the author A is a creation relationship. In this case, “work 1”, “author A”, and “creation relationship” are embedded into a vector based on a mapping relationship between each element in the triplet and the vector, to obtain third semantic information. A representation manner of the third semantic information is the semantic vector representation manner, and semantic content of the third semantic information is “a work 1 is created by an author A”.

Manner 2: Conversion is performed based on a semantic conversion model.

In other words, after obtaining the second semantic information, the receive device converts the second semantic information based on the semantic conversion model of the receive device, to obtain the third semantic information. The semantic conversion model may be configured by a network device or predefined in a protocol. It is not difficult to understand that semantic conversion is performed by using the semantic conversion model, so that a matching degree between the second semantic information and the third semantic information can be improved, and accuracy of the third semantic information obtained through conversion can be improved. For ease of differentiation and description, in the following descriptions of this disclosure, a semantic conversion model for converting the local semantic information into the common semantic information is referred to as a first semantic conversion model. For example, the foregoing semantic conversion model that is in the transmit device and that is for converting the first semantic information (namely, the local semantic information of the transmit device) into the second semantic information (namely, the common semantic information) may be referred to as the first semantic conversion model. A semantic model for converting the common semantic information into the local semantic information is referred to as a second semantic conversion model. For example, the semantic model that is in the receive device and that is for converting the second semantic information (namely, the common semantic information) into the third semantic information (namely, the local semantic information of the receive device) may be referred to as the second semantic conversion model.

In some embodiments, the receive device includes a semantic extraction model and a semantic understanding model, and the semantic extraction model and the semantic understanding model have a same cognition of the semantic information. In other words, the semantic extraction model and the semantic understanding model of the receive device are jointly trained. To be specific, after data is input into the semantic extraction model, the local semantic information (namely, semantic information whose representation manner is the same as that of the third semantic information) of the receive device is output, and an input of the semantic understanding model is the local semantic information of the receive device. It should be noted that, in this disclosure, only an example in which the semantic extraction model, the semantic understanding model, the first semantic conversion model, and the second semantic conversion model are decoupled is used for description, and should not be considered as a specific limitation on this disclosure. In other words, the following cases all fall within the protection scope of this disclosure: A model can implement a function of the semantic extraction model and a function of the first semantic conversion model in this disclosure, and a model can implement a function of the second semantic conversion model and a function of the semantic understanding model in this disclosure; or a model can implement a function of the semantic extraction model, a function of the first semantic conversion model, a function of the second semantic conversion model, and a function of the semantic understanding model.

In a possible implementation in this case, because the function of the second semantic conversion model is to convert the common semantic information into the local semantic information corresponding to the receive device, when the second semantic conversion model is trained, the common semantic information should be used as training data, and the local semantic information corresponding to the common semantic information is used as a label. In other words, a process in which the receive device trains the second semantic conversion model may be described as follows: The receive device inputs training data (referred to as second training data for short below) into the common semantic extraction model, to obtain training semantic information (referred to as second training semantic information for short below, namely, the common semantic information) corresponding to the second training data; the receive device inputs the second training data into the semantic extraction model of the receive device, to obtain label semantic information (referred to as second label semantic information for short below, namely, the local semantic information corresponding to the receive device) corresponding to the second training semantic information; and the receive device performs training based on the second training semantic information and the second label semantic information, to obtain the second semantic conversion model. In this way, an objective of the second semantic conversion model is to learn a mapping relationship between the second training semantic information and the second label semantic information, so that after the second training semantic information is input into the second semantic conversion model, second training semantic information obtained through conversion is as close as possible to the second label semantic information. The common semantic extraction model may be configured by the network device.

In another possible implementation in this case, the receive device inputs the second training data into the common semantic extraction model, to obtain the common semantic information corresponding to the second training data. Further, the receive device inputs the common semantic information corresponding to the second training data into a common semantic understanding model (namely, a semantic understanding model jointly trained with the common semantic extraction model), to obtain label information corresponding to the second training data. In addition, the receive device inputs the common semantic information corresponding to the second training data into the second semantic conversion model, and inputs semantic information obtained through conversion by the second semantic conversion model into the semantic understanding model, to obtain prediction information corresponding to the second training data. Further, a parameter of the second semantic conversion model is iteratively updated by minimizing a value of a loss function (e.g. a function for determining a difference between the prediction information and the label information corresponding to the second training data), to obtain an updated second semantic conversion model. The prediction information obtained by using the second semantic conversion model and the semantic understanding model is made as close as possible to the label information obtained by using the common semantic understanding model, so that the second semantic conversion model and the semantic understanding model of the receive device can accurately process the common semantic information. The common semantic extraction model and the common semantic understanding model may be configured by the network device.

In some embodiments, if the semantic understanding model of the receive device is the common semantic understanding model (namely, a semantic understanding model jointly trained with the common semantic extraction model), after obtaining the second semantic information, the receive device does not need to convert the second semantic information in S305, but may directly perform a step S306 of processing the second semantic information by using the semantic understanding model (namely, the common semantic understanding model), to obtain target information.

S306: The receive device processes the third semantic information to obtain the target information.

The receive device inputs the third semantic information into the semantic understanding model, to obtain the target information. It should be understood that the target information may be semantic content of the third semantic information (or the second semantic information), or information obtained by further processing the third semantic information.

It can be learned that, according to the communication method shown in S304 to S306, the receive device may convert the received common semantic information into the local semantic information corresponding to the receive device, to understand the local semantic information based on the semantic understanding model of the receive device, so that the target information is obtained. In this way, semantic communication can be performed between the transmit device and the receive device, so that accuracy of the semantic communication is improved.

In conclusion, according to the communication method shown in FIG. 3, this disclosure further provides a diagram of another semantic communication system. For details, refer to FIG. 4c. The semantic communication system includes a transmit device, a receive device, and a channel for communication between the transmit device and the receive device. The transmit device includes a semantic extraction model (or module), a first semantic conversion model (or module), and a channel encoding module. The receive device includes a channel decoding module (also referred to as a channel decoding module), a second semantic conversion model (or module), and a semantic understanding model (or module). It should be learned that an algorithm in the semantic extraction model, the first semantic conversion model, the second semantic conversion model, or the semantic understanding model includes but is not limited to one or more of the neural network, the DNN, the CNN, the RNN, or the GAN mentioned above.

In the semantic communication system shown in FIG. 4c, the transmit device extracts first semantic information from data by using the semantic extraction model of the transmit device, converts the first semantic information into second semantic information by using the first semantic conversion model, and then sends second semantic information to the receive device after performing channel encoding on the second semantic information by using the channel encoding module. After performing channel decoding on a signal from the transmit device by using the channel decoding module, the receive device obtains the second semantic information. Further, the receive device converts the second semantic information into third semantic information by using the second semantic conversion model, and processes the third semantic information by using the semantic understanding model of the receive device, to obtain target information.

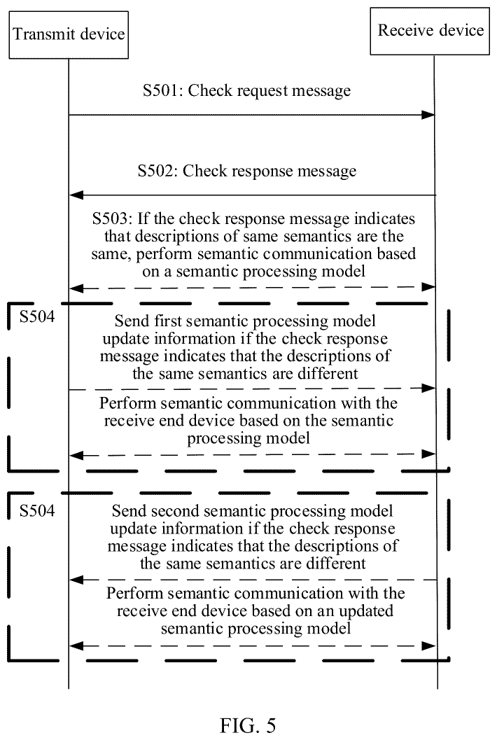

FIG. 5 is a schematic flowchart of another communication method according to an embodiment of this disclosure. The embodiment described in FIG. 5 is a supplement to the embodiment described in FIG. 3, or may be independent of the embodiment described in FIG. 3. In the embodiment described in FIG. 5, before performing semantic communication shown in FIG. 2 or semantic communication shown in FIG. 3, a transmit device and a receive device may first check whether the two parties have a same cognition of semantic information. After the two parties have the same cognition of the semantic information (or the two parties have the same cognition of the semantic information after calibration), semantic communication shown in FIG. 2 or FIG. 3 is performed. In FIG. 5, an example in which a communication device (e.g. the transmit device or the receive device) is used as an execution body of the method is used. The execution body of the method is not limited in this disclosure. For example, the communication device in FIG. 5 may alternatively be an apparatus, a chip, a chip system, or a processor that supports the communication device in implementing the method, or may be a logical module or software that can implement all or some of functions of the communication device.

S501: The transmit device sends a check request message to the receive device, where the check request message is for determining whether descriptions of same semantics that are provided by the receive device and the transmit device are the same.

The check request message includes test data and semantic information corresponding to the test data.

In other words, the transmit device sends the check request message to the receive device, where the check request message includes the test data and semantic information (namely, the semantic information corresponding to the test data) obtained by inputting the test data into a semantic processing model of the transmit device.

The semantic information corresponding to the test data needs to be described based on the semantic processing model used by the transmit device during semantic communication. Case 1: As shown in FIG. 2, if the semantic processing model used by the transmit device during the semantic communication is a semantic extraction model, the semantic information corresponding to the test data is semantic information output by the semantic extraction model. Case 2: As shown in FIG. 4c, if the semantic processing model used by the transmit device during the semantic communication is a semantic extraction model and a semantic conversion model, the semantic information corresponding to the test data is semantic information output by the semantic conversion model.

In some embodiments, before sending the check request message to the receive device, the transmit device may further send a semantic communication request message to the receive device, where the semantic communication request message is for requesting the receive device to perform semantic communication with the transmit device. After the receive device receives the semantic communication request message, the receive device sends a semantic communication acknowledgment message to the transmit device based on a capability of the receive device.

Specifically, after the receive device receives the semantic communication request message from the transmit device, the receive device determines, depending on whether the receive device has a semantic communication capability, a current processor load status of the receive device, a communication accuracy requirement, and the like, whether to perform semantic communication with the transmit device. When determining to perform semantic communication with the transmit device (for example, when having the semantic communication capability, when processor load is low, or when the communication accuracy requirement is low), the receive device sends the semantic communication acknowledgment message to the transmit device. Through implementation of the embodiment, semantic communication is performed only when both the receive device and the transmit device support the semantic communication, so that stability of the semantic communication can be improved.

S502: The transmit device receives a check response message from the receive device, where the check response message indicates whether the descriptions of the same semantics are the same.

After receiving the check request message, the receive device checks, based on the check request message, whether the receive device and the transmit device have a same description of the same semantics, and sends the check response message to the transmit device based on a check result.

It should be understood that an identity of the communication device (used as the receive device or used as the transmit device) in a process of performing semantic communication is not fixed. In other words, the communication device may be the receive device in the semantic communication, may be the transmit device in the semantic communication, or may be both the receive device and the transmit device. For example, a communication device 1 is used as the transmit device, and sends data 1 to a communication device 2 via the semantic communication system shown in FIG. 2 or FIG. 4c. In addition, the communication device 1 is used as the receive device, and receives, via the semantic communication system shown in FIG. 2 or FIG. 4c, data 2 sent by the communication device 2. In this process, the communication device 1 is both the transmit device and the receive device. It can be learned that a same communication device may have both the semantic processing model of the transmit device and a semantic processing model of the receive device. In addition, the semantic processing model used by the communication device as the transmit device and the semantic processing model used by the communication device as the receive device have a same description of same semantics. For example, the communication device 1 has both the semantic extraction model shown in FIG. 2 and the semantic understanding model shown in FIG. 2. In this case, the semantic extraction model and the semantic understanding model have a same description of same semantics. Alternatively, the communication device 1 has both a combination of the semantic extraction model and the first semantic conversion model shown in FIG. 4c and a combination of the second semantic conversion model and the semantic understanding model shown in FIG. 4c. In this case, the combination of the semantic extraction model and the first semantic conversion model and the combination of the second semantic conversion model and the semantic understanding model have a same description of same semantics.

Based on this, it can be inferred that, when the communication device 1 is used as the receive device in semantic communication, if the semantic extraction model (or the combination of the semantic extraction model and the first semantic conversion model) in the communication device 1 and the transmit device in the current semantic communication have a same description of same semantics, it may be considered that in the current semantic communication, the receive device and the transmit device have the same description of the same semantics.

The following describes, based on a semantic processing model used by a receive end during the semantic communication, a process of checking whether the receive device and the transmit device have the same description of the same semantics.

Case 1: The semantic processing model used by the receive device during the semantic communication is the semantic understanding model. In other words, in the current semantic communication, semantic communication shown in FIG. 2 is performed between the receive device and the transmit device. In this case, if the semantic extraction model of the receive device and the semantic extraction model of the transmit device have the same description of the same semantics, it may be considered that in the current semantic communication, the receive device and the transmit device have the same description of the same semantics. Therefore, in this case, if semantic information obtained by the receive device by inputting the test data into the semantic extraction model of the receive device is the same as the semantic information corresponding to the test data in the check request message, it may be considered that the semantic processing model (namely, the semantic understanding model) used when the receive device performs current semantic communication and the semantic processing model (namely, the semantic extraction model) used when the transmit device performs current semantic communication have a same cognition of the semantic information. Further, the receive device sends a check response request to the transmit device, where the check response request indicates that the descriptions of the same semantics are the same. On the contrary, if semantic information obtained by the receive device by inputting the test data into the semantic extraction model of the receive device is different from the semantic information corresponding to the test data in the check request message, the check response request is sent to the transmit device, where the check response request indicates that the descriptions of the same semantics are different.

Case 2: The semantic processing model used by the receive device during the semantic communication is the semantic understanding model and the second semantic conversion model. In other words, in the current semantic communication, semantic communication shown in FIG. 4c is performed between the receive device and the transmit device. In this case, if the combination of the semantic extraction model and the first semantic conversion model of the receive device and the combination of the semantic extraction model and the first semantic conversion model of the transmit device have the same description of the same semantics, it may be considered that in the current semantic communication, the receive device and the transmit device have the same description of the same semantics. Therefore, in this case, if semantic information obtained by the receive device by inputting the test data into the semantic extraction model and the first semantic conversion model of the receive device is the same as the semantic information corresponding to the test data in the check request message, it may be considered that the semantic processing model (namely, the combination of the second semantic conversion model and the semantic understanding model) used when the receive device performs current semantic communication and the semantic processing model (namely, the combination of the semantic extraction model and the first semantic conversion model) used when the transmit device performs current semantic communication have a same cognition of the semantic information. Further, the receive device sends a check response request to the transmit device, where the check response request indicates that the descriptions of the same semantics are the same. On the contrary, if semantic information obtained by the receive device by inputting the test data into the semantic extraction model and the first semantic conversion model of the receive device is different from the semantic information corresponding to the test data in the check request message, the check response request is sent to the transmit device, where the check response request indicates that the descriptions of the same semantics are different.

S503: If the check response message indicates that the descriptions of the same semantics are the same, perform semantic communication with the receive device based on the semantic processing model.

The semantic processing model includes one or more of a semantic extraction model, a semantic understanding model, or a semantic conversion model. In other words, if the check response message indicates that the descriptions of the same semantics are the same, based on the communication method shown in FIG. 2, the transmit device may perform semantic communication with the receive device based on the semantic extraction model of the transmit device and the semantic understanding model of the receive device. Alternatively, based on the communication method shown in FIG. 3, the transmit device may perform semantic communication with the receive device based on the semantic extraction model and the first semantic conversion model of the transmit device, and the semantic understanding model and the second semantic conversion model of the receive device.

S504: If the check response message indicates that the descriptions of the same semantics are different, send first semantic processing model update information to the receive device, and perform semantic communication with the receive device based on the semantic processing model; or receive second semantic processing model update information from the receive device, update the semantic processing model based on the second semantic processing model update information, and perform semantic communication with the receive device based on an updated semantic processing model.

In other words, if the check response message indicates that the descriptions of the same semantics are different, the transmit device may send the first semantic processing model update information to the receive device, so that the receive device updates the semantic processing model. Further, semantic communication is performed based on the semantic processing model that is not updated by the transmit device and the semantic processing model that is updated by the receive device. Alternatively, the transmit device receives the second semantic processing model update information from the receive device, and updates the semantic processing model of the transmit device. Further, semantic communication is performed based on the semantic processing model updated by the transmit device and the semantic processing model that is not updated by the receive device. Alternatively, the transmit device sends the first semantic processing model update information to the receive device, to enable the receive device to update the semantic processing model, and the transmit device receives the second semantic processing model update information from the receive device. Further, semantic communication is performed based on the semantic processing model updated by the transmit device and the semantic processing model updated by the receive device.

In some embodiments, the first semantic processing model update information includes a first training dataset, and the first training dataset includes data of the transmit device and corresponding label semantic information. In this case, the receive device updates the semantic processing model of the receive device based on the first training dataset.

In other words, the first training dataset is local data of the transmit device and semantic information (the label semantic information) that corresponds to the local data and that is obtained by the transmit device by using the semantic processing model. The receive device updates a model parameter of the semantic processing model of the receive device based on the data and the label information in the first training dataset, to obtain the updated semantic processing model of the receive device.

In some embodiments, the second semantic processing model update information includes a second training dataset, and the second training dataset includes data of the receive device and corresponding label semantic information. In this case, the transmit device updates the semantic processing model of the transmit device based on the second training dataset.

In other words, the second training dataset is local data of the receive device and semantic information (e.g. the label semantic information) that corresponds to the local data and that is obtained by the receive device by using the semantic processing model. The transmit device updates a model parameter of the semantic processing model of the transmit device based on the data and the label information in the second training dataset, to obtain the updated semantic processing model of the transmit device.

It can be learned that, based on the method described in FIG. 5, when the receive device and the transmit device do not perform joint training, semantic communication can be directly performed if the descriptions of the same semantics are the same. The semantic processing model is updated only when the descriptions of the same semantics are different, and semantic communication is performed based on the updated semantic processing model. When the receive device and the transmit device do not perform joint training, it is ensured that the transmit device and the receive device can perform semantic communication, and communication resources are saved.

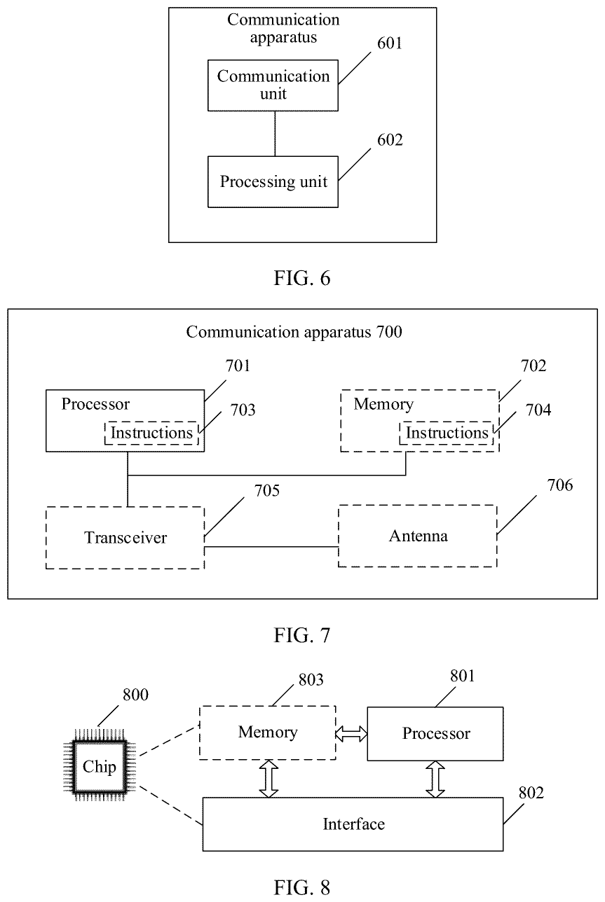

FIG. 6 is a diagram of a structure of a communication apparatus according to an embodiment of this disclosure. The communication apparatus shown in FIG. 6 may be configured to perform some or all functions of the transmit device in the foregoing method embodiments. The apparatus may be a transmit device, may be an apparatus in the transmit device, or may be an apparatus that can be used together with the transmit device. The communication apparatus may alternatively be a chip system. The communication apparatus shown in FIG. 6 may include a communication unit 601 and a processing unit 602. The processing unit 602 is configured to perform data processing. The communication unit 601 is integrated with a receiving unit and a sending unit. The communication unit 601 may also be referred to as a transceiver unit. Alternatively, the communication unit 601 may be split into a receiving unit and a sending unit.

The processing unit 602 is configured to obtain first semantic information corresponding to data. The processing unit 602 is configured to convert the first semantic information into second semantic information, where the second semantic information belongs to common semantic information, and the common semantic information is a unified description of same semantics that is provided by different devices. The communication unit 601 is configured to send the second semantic information.

In some embodiments, the processing unit 602 is further configured to perform semantic conversion on the first semantic information based on a semantic conversion model, to obtain the second semantic information.

In some embodiments, the first semantic information is obtained by inputting the data into a semantic extraction model. In this case, the processing unit 602 is further configured to: input training data into the semantic extraction model, to obtain training semantic information; input the training data into a common semantic extraction model, to obtain label semantic information, where the label semantic information belongs to the common semantic information; and perform training based on the training semantic information and the label semantic information, to obtain the semantic conversion model.

In some embodiments, the common semantic extraction model is configured by a network device.

In some embodiments, the processing unit 602 is further configured to perform semantic conversion on the first semantic information based on a representation manner of the common semantic information, to obtain the second semantic information.

In some embodiments, the representation manner of the common semantic information is configured by a network device or is pre-specified in a protocol.

In some embodiments, the representation manner of the common semantic information includes a semantic vector representation manner, a triplet representation manner, or a directed graph representation manner.

In some embodiments, the second semantic information and the first semantic information correspond to a same semantic level.

FIG. 6 is a diagram of a structure of a communication apparatus according to an embodiment of this disclosure. The communication apparatus shown in FIG. 6 may be configured to perform some or all functions of the receive device in the foregoing method embodiments. The apparatus may be a receive device, may be an apparatus in the receive device, or may be an apparatus that can be used together with the receive device. The communication apparatus may alternatively be a chip system. The communication apparatus shown in FIG. 6 may include a communication unit 601 and a processing unit 602. The processing unit 602 is configured to perform data processing. The communication unit 601 is integrated with a receiving unit and a sending unit. The communication unit 601 may also be referred to as a transceiver unit. Alternatively, the communication unit 601 may be split into a receiving unit and a sending unit.

The communication unit 601 is configured to receive second semantic information, where the second semantic information belongs to common semantic information, and the common semantic information is a unified description of same semantics that is provided by different devices. The processing unit 602 is configured to convert the second semantic information into third semantic information. The processing unit 602 is further configured to process the third semantic information to obtain target information.

In some embodiments, the processing unit 602 is further configured to perform semantic conversion on the second semantic information based on a semantic conversion model, to obtain the third semantic information.

In some embodiments, the target information is obtained by inputting the third semantic information into a semantic understanding model. In this case, the processing unit 602 is further configured to input training data into a semantic extraction model, to obtain label semantic information, where the semantic extraction model and the semantic understanding model are jointly trained. The processing unit 602 is further configured to input the training data into a common semantic extraction model, to obtain training semantic information corresponding to the training data. The processing unit 602 is further configured to perform training based on the training semantic information and the label semantic information, to obtain the semantic conversion model.

In some embodiments, the common semantic extraction model is configured by a network device.

In some embodiments, the processing unit 602 is further configured to perform semantic conversion on the second semantic information based on a representation manner of the common semantic information, to obtain the third semantic information.

In some embodiments, the representation manner of the common semantic information includes a semantic vector representation manner, a triplet representation manner, or a directed graph representation manner.

In some embodiments, the third semantic information and the second semantic information correspond to a same semantic level.

FIG. 6 is a diagram of a structure of a communication apparatus according to an embodiment of this disclosure. The communication apparatus shown in FIG. 6 may be configured to perform some or all functions of the transmit device in the foregoing method embodiments. The apparatus may be a transmit device, may be an apparatus in the transmit device, or may be an apparatus that can be used together with the transmit device. The communication apparatus may alternatively be a chip system. The communication apparatus shown in FIG. 6 may include a communication unit 601 and a processing unit 602. The processing unit 602 is configured to perform data processing. The communication unit 601 is integrated with a receiving unit and a sending unit. The communication unit 601 may also be referred to as a transceiver unit. Alternatively, the communication unit 601 may be split into a receiving unit and a sending unit.

The communication unit 601 is configured to send a check request message to a receive device, where the check request message is for determining whether descriptions of same semantics that are provided by the receive device and the transmit device are the same. The communication unit 601 is configured to receive a check response message from the receive device, where the check response message indicates whether the descriptions of the same semantics are the same; and if the check response message indicates that the descriptions of the same semantics are the same, the communication unit 601 performs semantic communication with the receive device based on a semantic processing model; or if the check response message indicates that the descriptions of the same semantics are different, the communication unit 601 is configured to send first semantic processing model update information to the receive device, and perform semantic communication with the receive device based on a semantic processing model; or the communication unit 601 is configured to receive second semantic processing model update information from the receive device, the processing unit 602 is configured to update a semantic processing model based on the second semantic processing model update information, and the communication unit 601 is further configured to perform semantic communication with the receive device based on an updated semantic processing model.

In some embodiments, the semantic processing model includes one or more of a semantic extraction model, a semantic understanding model, or a semantic conversion model.

In some embodiments, the first semantic processing model update information includes a first training dataset, and the first training dataset includes data of the transmit device and corresponding label semantic information.

In some embodiments, the second semantic processing model update information includes a second training dataset, and the second training dataset includes the data of the receive device and corresponding label semantic information. In this case, the processing unit 602 is configured to update the semantic processing model of the processing unit 602 based on the second training dataset.

In some embodiments, before sending the check request message to the receive device, the communication unit 601 is configured to: send a semantic communication request message to the receive device; and receive a semantic communication acknowledgment message from the receive device.

In some embodiments, the check request message includes test data and semantic information corresponding to the test data.

FIG. 6 is a diagram of a structure of a communication apparatus according to an embodiment of this disclosure. The communication apparatus shown in FIG. 6 may be configured to perform some or all functions of the receive device in the foregoing method embodiments. The apparatus may be a receive device, may be an apparatus in the receive device, or may be an apparatus that can be used together with the receive device. The communication apparatus may alternatively be a chip system. The communication apparatus shown in FIG. 6 may include a communication unit 601 and a processing unit 602. The processing unit 602 is configured to perform data processing. The communication unit 601 is integrated with a receiving unit and a sending unit. The communication unit 601 may also be referred to as a transceiver unit. Alternatively, the communication unit 601 may be split into a receiving unit and a sending unit.

The communication unit 601 is configured to receive, for a receive device, a check request message from a transmit device, where the check request message is for determining whether descriptions of same semantics that are provided by the receive device and the transmit device are the same. The communication unit 601 is further configured to send a check response message to the transmit device, where the check response message indicates whether the descriptions of the same semantics are the same; and if the check response message indicates that the descriptions of the same semantics are the same, the communication unit 601 performs semantic communication with the transmit device based on a semantic processing model; or if the check response message indicates that the descriptions of the same semantics are different, the communication unit 601 is further configured to receive first semantic processing model update information from the transmit device, and the processing unit 602 is configured to update a semantic processing model based on the first semantic processing model update information; or the communication unit 601 is further configured to: send second semantic processing model update information to the transmit device, and perform semantic communication with the transmit device based on a semantic processing model.

In some embodiments, the semantic processing model includes one or more of a semantic extraction model, a semantic understanding model, or a semantic conversion model.

In some embodiments, the first semantic processing model update information includes a first training dataset, and the first training dataset includes data of the transmit device and corresponding label semantic information. In this case, the processing unit 602 is configured to update the semantic processing model based on the first training dataset.

In some embodiments, the second semantic processing model update information includes a second training dataset, and the second training dataset includes data of the receive device and corresponding label semantic information.

In some embodiments, before receiving the check request message from the transmit device, the communication unit 601 is further configured to: receive a semantic communication request message from the transmit device; and send a semantic communication acknowledgment message to the transmit device based on the semantic communication request message.

In some embodiments, the check request message includes test data and semantic information corresponding to the test data.

FIG. 7 is a diagram of a structure of another communication apparatus. The communication apparatus 700 may be the transmit device or the receive device in the foregoing method embodiments, or may be a chip, a chip system, a processor, or the like that supports the transmit device or the receive device in implementing the foregoing methods. The communication apparatus may be configured to implement the method described in the foregoing method embodiments. For details, refer to the descriptions in the foregoing method embodiments.

The communication apparatus 700 may include one or more processors 701. The processor 701 may be a general-purpose processor or a special-purpose processor or the like, for example, may be a baseband processor or a central processing unit. The baseband processor may be configured to process a communication protocol and communication data. The central processing unit may be configured to: control a communication apparatus (for example, a base station, a baseband chip, a terminal, a terminal chip, a DU, or a CU), execute a software program, and process data of the software program.

Optionally, the communication apparatus 700 may include one or more memories 702. The one or more memories 702 may store instructions 704, and the instructions may be run on the processor 701, so that the communication apparatus 700 performs the method described in the foregoing method embodiments. Optionally, the memory 702 may also store data. The processor 701 and the memory 702 may be separately disposed, or may be integrated together.

Optionally, the communication apparatus 700 may further include a transceiver 705 and an antenna 706. The transceiver 705 may be referred to as a transceiver unit, a transceiver machine, a transceiver circuit, or the like, and is configured to implement a transceiver function. The transceiver 705 may include a receiver and a transmitter. The receiver may be referred to as a receiver machine, a receiver circuit, or the like, and is configured to implement a receiving function. The transmitter may be referred to as a transmitter machine, a transmitter circuit, or the like, and is configured to implement a sending function. The processing unit 602 shown in FIG. 6 may be the processor 701. The communication unit 601 may be the transceiver 705.

In some embodiments, the processor 701 may include a transceiver configured to implement receiving and sending functions. For example, the transceiver may be a transceiver circuit, an interface, or an interface circuit. The transceiver circuit, the interface, or the interface circuit configured to implement the receiving and sending functions may be separated, or may be integrated together. The transceiver circuit, the interface, or the interface circuit may be configured to read and write code/data. Alternatively, the transceiver circuit, the interface, or the interface circuit may be configured to transmit or transfer a signal.

In some embodiments, the processor 701 may store instructions 703, and the instructions 703 are run on the processor 701, so that the communication apparatus 700 can perform the method described in the foregoing method embodiments. The instructions 703 may be fixed in the processor 701, and in this case, the processor 701 may be implemented by using hardware.

In some embodiments, the communication apparatus 700 may include a circuit, and the circuit may implement a sending, receiving, or communication function in the foregoing method embodiments. The processor and the transceiver described in this embodiment of this disclosure may be implemented on an integrated circuit (IC), an analog IC, a radio frequency integrated circuit (RFIC), a hybrid signal IC, an application-specific integrated circuit (ASIC), a printed circuit board (PCB), an electronic device, or the like. The processor and the transceiver may alternatively be manufactured by using various IC technologies, for example, a complementary metal oxide semiconductor (CMOS), an n-type metal oxide semiconductor (NMOS), a p-type metal oxide semiconductor (PMOS), a bipolar junction transistor (BJT), a bipolar CMOS (BiCMOS), silicon germanium (SiGe), and gallium arsenide (GaAs).

The communication apparatus described in the foregoing embodiments may be a transmit device or a receive device. However, a scope of the communication apparatus described in embodiments of this disclosure is not limited thereto, and a structure of the communication apparatus may not be limited by FIG. 6 or FIG. 7. The communication apparatus may be an independent device or may be a part of a large device. For example, the communication apparatus may be:
(1) an independent integrated circuit (IC), a chip, or a chip system or subsystem;
(2) a set that has one or more ICs, where optionally, the IC set may alternatively include a storage component configured to store data and instructions;
(3) an ASIC, for example, a modem (MSM);
(4) a module that can be embedded in another device;
(5) a receiver, a terminal, an intelligent terminal, a cellular phone, a wireless device, a handheld device, a mobile unit, a vehicle-mounted device, a network device, a cloud device, an artificial intelligence device, or the like; or
(6) others.

For a case in which the communication apparatus may be the chip or the chip system, refer to a diagram of a structure of a chip shown in FIG. 8. The chip 800 shown in FIG. 8 includes a processor 801 and an interface 802. Optionally, the chip 800 may further include a memory 803. There may be one or more processors 801, and there may be a plurality of interfaces 802.

For a case in which the chip is configured to implement a function of the transmit device or the receive device in embodiments of this disclosure:

The interface 802 is configured to receive or output a signal.

The processor 801 is configured to perform a data processing operation of the transmit device or the receive device.

It may be understood that in some scenarios, some optional features in embodiments of this disclosure may be independently implemented without depending on another feature, for example, a solution on which the optional features are currently based, to resolve a corresponding technical problem and achieve corresponding effects. Alternatively, in some scenarios, the optional features may be combined with other features based on a requirement. Correspondingly, the communication apparatus provided in embodiments of this disclosure may also correspondingly implement these features or functions.

It should be understood that the processor in embodiments of this disclosure may be an integrated circuit chip, and has a signal processing capability. In an implementation process, steps in the foregoing method embodiments can be implemented by using a hardware integrated logical circuit in the processor, or by using instructions in a form of software. The foregoing processor may be a general-purpose processor, a digital signal processor (DSP), an application-specific integrated circuit (ASIC), a field programmable gate array (FPGA) or another programmable logic device, a discrete gate or transistor logic device, or a discrete hardware component.

It may be understood that the memory in embodiments of this disclosure may be a volatile memory or a non-volatile memory, or may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. By way of example and not limitation, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM). It should be noted that the memory of the systems and methods described in this specification includes but is not limited to these and any memory of another proper type.

This disclosure further provides a computer-readable medium. The storage medium stores a computer program or instructions. When the computer program or the instructions are executed by a communication apparatus, a function in any one of the foregoing method embodiments is implemented.

This disclosure further provides a computer program product including instructions. When a computer reads and executes the computer program product, the computer is enabled to implement a function in any one of the foregoing method embodiments.

All or some of the foregoing embodiments may be implemented by using software, hardware, firmware, or any combination thereof. When software is used to implement embodiments, all or some of embodiments may be implemented in a form of a computer program product. The computer program product includes one or more computer instructions. When the computer instructions are loaded and executed on the computer, the procedure or functions according to embodiments of this disclosure are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a high-density digital video disc (DVD)), a semiconductor medium (for example, a solid-state drive (SSD)), or the like.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. A communication method, comprising:
obtaining, by a first device, first semantic information corresponding to data;
converting, by the first device, the first semantic information into second semantic information, wherein the second semantic information belongs to common semantic information, and the common semantic information is a unified description of same semantics that are provided by different devices; and
sending, by the first device, the second semantic information to a second device.

2. The method according to claim 1, wherein the converting the first semantic information into second semantic information comprises:
performing semantic conversion on the first semantic information based on a semantic conversion model to obtain the second semantic information.

3. The method according to claim 2, wherein the first semantic information is obtained by inputting the data into a semantic extraction model, and the method further comprises:
inputting training data into the semantic extraction model to obtain training semantic information;
inputting the training data into a common semantic extraction model to obtain label semantic information, wherein the label semantic information belongs to the common semantic information; and
performing training based on the training semantic information and the label semantic information to obtain the semantic conversion model.

4. The method according to claim 3, wherein the common semantic extraction model is configured by a network device.

5. The method according to claim 1, wherein the converting the first semantic information into second semantic information comprises:
performing semantic conversion on the first semantic information based on a representation manner of the common semantic information to obtain the second semantic information.

6. The method according to claim 5, wherein the representation manner of the common semantic information is configured by a network device or is pre-specified in a protocol.

7. The method according to claim 5, wherein the representation manner of the common semantic information comprises a semantic vector representation manner, a triplet representation manner, or a directed graph representation manner.

8. The method according to claim 1, wherein the second semantic information and the first semantic information correspond to a same semantic level.

9. A communication method, comprising:
receiving, by a second device from a first device, second semantic information, wherein the second semantic information belongs to common semantic information, and the common semantic information is a unified description of same semantics that are provided by different devices;
converting, by the second device, the second semantic information into third semantic information; and
processing, by the second device, the third semantic information to obtain target information.

10. The method according to claim 9, wherein the converting the second semantic information into third semantic information comprises:
performing semantic conversion on the second semantic information based on a semantic conversion model to obtain the third semantic information.

11. The method according to claim 10, wherein the target information is obtained by inputting the third semantic information into a semantic understanding model, and the method further comprises:
inputting training data into a semantic extraction model to obtain label semantic information, wherein the semantic extraction model and the semantic understanding model are jointly trained;
inputting the training data into a common semantic extraction model to obtain training semantic information corresponding to the training data; and
performing training based on the training semantic information and the label semantic information to obtain the semantic conversion model.

12. The method according to claim 11, wherein the common semantic extraction model is configured by a network device.

13. The method according to claim 9, wherein the converting the second semantic information into third semantic information comprises:
performing semantic conversion on the second semantic information based on a representation manner of the common semantic information to obtain the third semantic information.

14. The method according to claim 13, wherein the representation manner of the common semantic information comprises a semantic vector representation manner, a triplet representation manner, or a directed graph representation manner.

15. The method according to claim 9, wherein the third semantic information and the second semantic information correspond to a same semantic level.

16. A communication apparatus, comprising at least one processor and at least one memory storing programming instructions, wherein the at least one processor is coupled to the at least one memory and executes the programming instructions to:
obtain first semantic information corresponding to data;
convert the first semantic information into second semantic information, wherein the second semantic information belongs to common semantic information, and the common semantic information is a unified description of same semantics that are provided by different devices; and
sending the second semantic information to a second communication apparatus.

17. The communication apparatus according to claim 16, wherein the converting the first semantic information into second semantic information comprises:
performing semantic conversion on the first semantic information based on a semantic conversion model to obtain the second semantic information.

18. The communication apparatus according to claim 17, wherein the first semantic information is obtained by inputting the data into a semantic extraction model, and the at least one processor executes the programming instructions to:
input training data into the semantic extraction model to obtain training semantic information;
input the training data into a common semantic extraction model, to obtain label semantic information, wherein the label semantic information belongs to the common semantic information; and
perform training based on the training semantic information and the label semantic information to obtain the semantic conversion model.

19. The communication apparatus according to claim 18, wherein the common semantic extraction model is configured by a network device.

20. The communication apparatus according to claim 16, wherein the second semantic information and the first semantic information correspond to a same semantic level.
